(19) United States
(12) Patent Application Publication
(10) Pub. No.: US 2018/0061599 A1
(43) Pub. Date: Mar. 1, 2018

(54) CONTACT DEVICE, HOUSING CASE USED FOR CONTACT DEVICE, AND ELECTROMAGNETIC RELAY EQUIPPED WITH CONTACT DEVICE

(71) Applicant: PANASONIC INTELLECTUAL PROPERTY MANAGEMENT CO., LTD., Osaka (JP)

(72) Inventors: Hideki ENOMOTO, Osaka (JP); Satoshi SAKAI, Osaka (JP)

(73) Assignee: PANASONIC INTELLECTUAL PROPERTY MANAGEMENT CO., LTD., Osaka (JP)

(21) Appl. No.: 15/684,323

(22) Filed: Aug. 23, 2017

(30) Foreign Application Priority Data
Aug. 26, 2016 (JP) 2016-165668

(51) Int. Cl. H01H 50/08; H01H 50/06; H01H 50/54

(52) U.S. Cl. CPC H01H 50/08; H01H 50/54; H01H 50/06

(57) ABSTRACT

A contact device includes: a contact block including fixed contacts and movable contacts brought into contact with and separated from the fixed contacts; and a drive block configured to bring the movable contacts into contact with the fixed contacts and separate the movable contacts from the fixed contacts. The contact block includes: a contact unit including the fixed contacts and the movable contacts; a housing case having a housing space for housing the contact unit; and a window portion provided on a wall portion of the housing case and having higher light transmission than the wall portion.

### CROSS REFERENCE TO RELATED APPLICATIONS

This application is based upon and claims the benefit of priority from prior Japanese Patent Application P2016-165668 filed on Aug. 26, 2016; the entire contents of which are incorporated by reference herein.

### BACKGROUND OF THE INVENTION

The present invention relates to a contact device, a housing case used for the contact device, and an electromagnetic relay equipped with the contact device.

JP 2016-027560 (hereinafter, referred to as Patent Literature 1) discloses a switching assembly including a contact block including fixed contacts and movable contacts brought into contact with and separated from the fixed contacts, and a drive block for bringing the movable contacts into contact with the fixed contacts and separating the movable contacts from the fixed contacts.

The switching assembly disclosed in Patent Literature 1 carries out the switching operation between contact and separation of the movable contacts and the fixed contacts such that a motor is driven to move a movable iron core connected to the movable contacts via a shaft.

Patent Literature 1 discloses a housing which houses the movable iron core and is provided with an opening through which a position of the movable iron core is detected, so as to confirm the operation of a contact unit (the movable contacts and the fixed contacts).

However, the switching assembly cannot detect the movement of the contact unit when the movement of the movable contacts is not linked with the movement of the movable iron core because the switching assembly indirectly confirms the operation of the contact unit (the movable contacts and the fixed contacts) by detecting the position of the movable iron core.

### SUMMARY OF THE INVENTION

An object of the present invention is to provide a contact device capable of accurately detecting an operation of a contact unit, a housing case used for the contact device, and an electromagnetic relay equipped with the contact device.

A contact device according to the present invention includes: a contact block including fixed contacts and movable contacts brought into contact with and separated from the fixed contacts; and a drive block configured to bring the movable contacts into contact with the fixed contacts and separate the movable contacts from the fixed contacts.

The contact block includes: a contact unit including the fixed contacts and the movable contacts; a housing case having a housing space for housing the contact unit; and a window portion provided on a wall portion of the housing case and having higher light transmission than the wall portion.

A housing case according to the present invention is used for the contact device.

An electromagnetic relay according to the present invention is equipped with the contact device.

### BRIEF DESCRIPTION OF THE DRAWINGS

FIG. 1 is a cross-sectional view of an electromagnetic relay according to an embodiment of the present invention.

FIG. 2 is a cross-sectional view of a contact device according to the embodiment of the present invention.

FIG. 3 is a schematic view illustrating a method of detecting an operation of a contact unit in the contact device according to the embodiment of the present invention, showing a state in which a movable contact is separated from a fixed contact.

FIG. 4 is a schematic view illustrating the method of detecting the operation of the contact unit in the contact device according to the embodiment of the present invention, showing a state in which the movable contact is in contact with the fixed contact.

FIG. 5 is a schematic view illustrating a circuit configuration of a detection unit according to the embodiment of the present invention.

FIG. 6 is a schematic view of a modified example of the contact device according to the embodiment of the present invention.

FIG. 7 is a schematic view of a first modified example of a window portion according to the embodiment of the present invention.

FIG. 8 is a schematic view of a second modified example of the window portion according to the embodiment of the present invention.

FIG. 9 is a schematic view of the window portion and a metal frame according to the embodiment of the present invention.

FIG. 10 is a schematic view of the window portion and a modified example of the metal frame according to the embodiment of the present invention.

FIG. 11 is a schematic view of an example of an outline of the window portion and the metal frame according to the embodiment of the present invention.

FIG. 12 is a schematic view of another example of the outline of the window portion and the metal frame according to the embodiment of the present invention.

### DESCRIPTION OF THE EMBODIMENTS

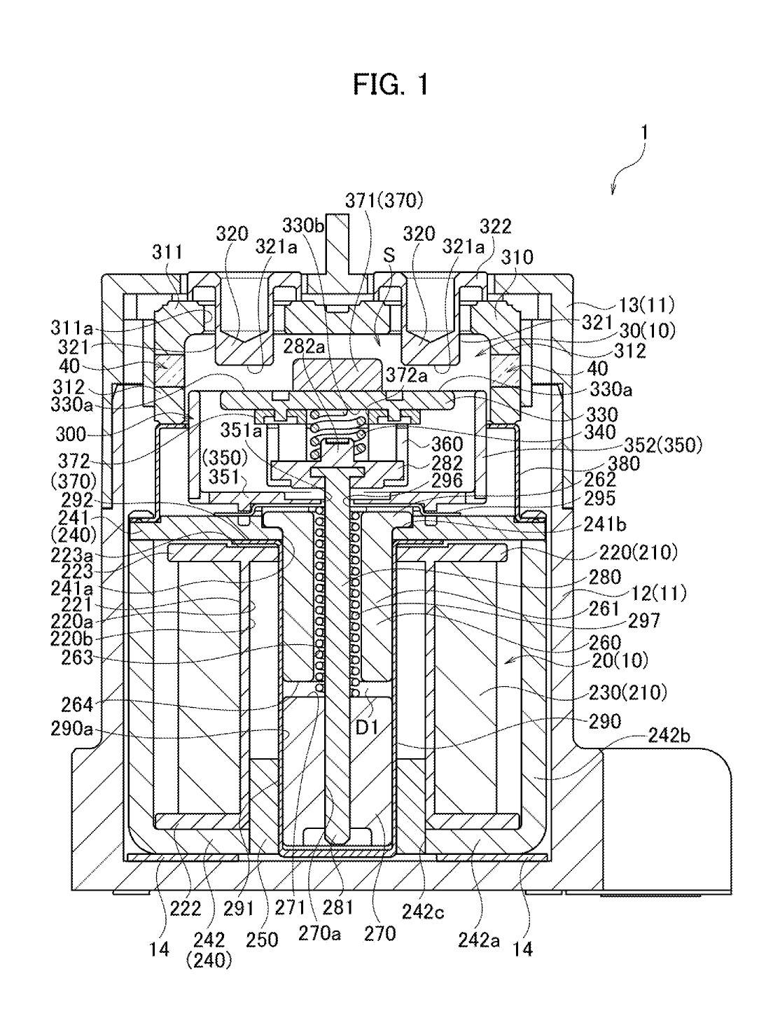

Hereinafter, an embodiment of the present invention will be described with reference to the drawings. As used herein, the definitions of the top, bottom, right, and left applied to FIG. 1 are used for the explanations of the drawings throughout the Specification. The direction perpendicular to the paper of FIG. 1 is referred to as a front-rear direction.

An electromagnetic relay 1 according to the present embodiment is of a normally open type in which contacts are OFF in an initial state. As shown in FIG. 1, the electromagnetic relay 1 includes a contact device 10 including a drive block 20 located on the lower side and a contact block 30 located on the upper side, in which the drive block 20 and the contact block 30 are integrated together. The contact device 10 is housed in a case 11 formed into a hollow box shape and made of a resin material. An electromagnetic relay of a normally closed type in which contacts are ON in an initial state may be used instead.

The case 11 includes a substantially box-shaped case body 12 open on the upper side, and a case cover 13 covering the opening of the case body 12. The contact device 10 (the drive block 20 and the contact block 30) is housed in the inside space of the case 11 with the case body 12 covered with the case cover 13. In the present embodiment, a damper rubber 14 made of an elastic rubber material is placed on the bottom of the case body 12. The drive block 20 is installed on the bottom of the case body 12 with the damper rubber 14 interposed therebetween.

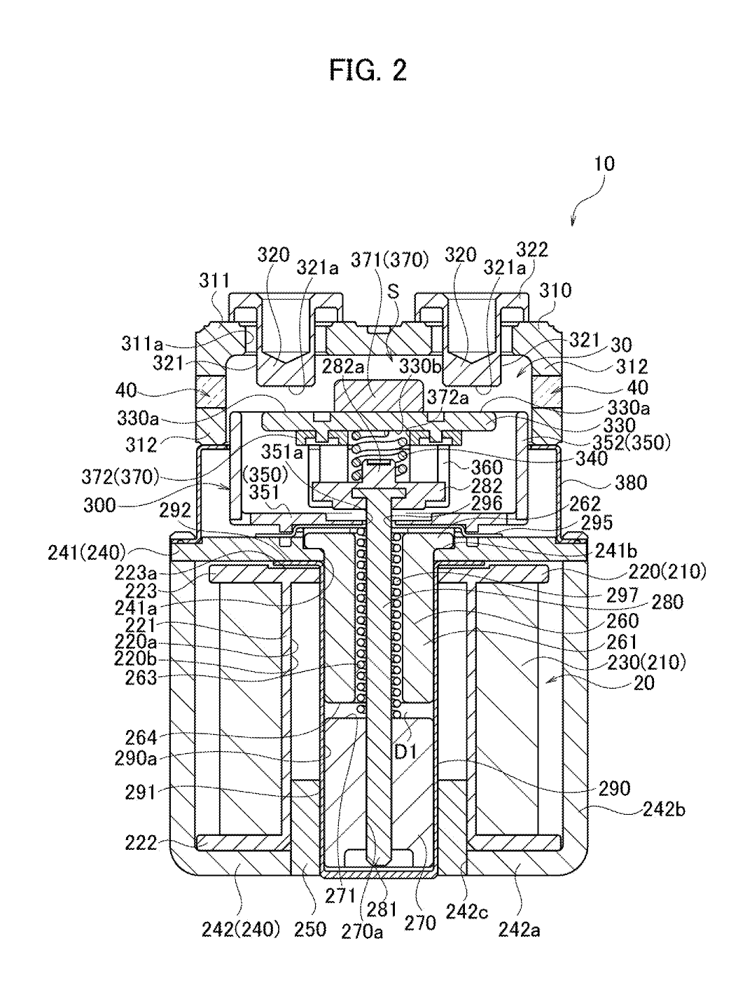

The drive block 20 includes a coil unit 210. The coil unit 210 includes a coil 230 which generates magnetic flux when a current is applied thereto, and a cylindrical hollow coil bobbin 220 on which the coil 230 is wound, as shown in FIG. 1 and FIG. 2.

Although not illustrated in the drawings, a pair of coil terminals is fixed to the coil bobbin 220 and connected to both ends of the coil 230. The drive block 20 is driven when the current is applied to the coil 230 through the pair of coil terminals. The driven drive block 20 operates to open and close fixed contacts 321a and movable contacts 330a of the contact block 30, as described below, so as to switch an electrical connection between a pair of fixed terminals 320.

The coil bobbin 220 is made of an insulating resin material and provided with an insertion hole 220a penetrating the middle of the coil bobbin 220 in the vertical direction. The coil bobbin 220 includes a wound body 221 having a substantially cylindrical shape on which the coil 230 is wound around the outer surface, a lower flange 222 having a substantially circular shape continuously formed on the bottom of the wound body 221 and extending outward in the radial direction of the wound body 221, and an upper flange 223 having a substantially circular shape continuously formed on the top of the wound body 221 and extending outward in the radial direction of the wound body 221. In the present embodiment, the upper flange 223 also protrudes inward in the radial direction of the wound body 221. The diameter of the opening of the insertion hole 220a is smaller on the upper side than on the lower side.

The drive block 20 further includes a yoke 240 made of a magnetic material and surrounding the coil bobbin 220. In the present embodiment, the yoke 240 includes a rectangular yoke upper plate 241 located on the upper surface of the coil bobbin 220, and a rectangular yoke 242 arranged along the lower surface and the side surface of the coil bobbin 220.

The yoke 242 is located between the coil 230 and the case 11. The yoke 242 includes a bottom wall 242a and a pair of side walls 242b extending upward from right and left edges (circumferential edges) of the bottom wall 242a, and is open in the front-rear direction. The bottom wall 242a and the pair of the side walls 242b may be integrally formed such that a single plate is bent. The bottom wall 242a of the yoke 242 is provided with a circular insertion hole 242c into which a bushing 250 made of a magnetic material is inserted.

The yoke upper plate 241 is placed on the end side (on the upper side) of the pair of the side walls 242b of the yoke 242 to cover the upper surface of the coil bobbin 220 and the coil 230 wound on the coil bobbin 220.

The drive block 20 includes a fixed iron core 260 which is placed in the cylindrical inner portion (in the insertion hole 220a) of the coil bobbin 220 and magnetized by the coil 230 applied with the current (allows the magnetic flux to flow therethrough), and a movable iron core 270 which is opposed to the fixed iron core 260 in the vertical direction (in the shaft direction) and placed in the cylindrical inner portion (in the insertion hole 220a) of the coil bobbin 220.

The fixed iron core 260 includes a cylinder portion 261 inserted into the cylindrical inner portion (in the insertion hole 220a) of the coil bobbin 220, and a flange 262 extending outward in the radial direction from the upper end of the cylinder portion 261. The fixed iron core 260 is provided with an insertion hole 263 into which a shaft (a drive shaft) 280 and a return spring 297 are inserted. The movable iron core 270 is provided with an insertion hole 270a to which the shaft (the drive shaft) 280 is inserted and fixed.

The shaft 280 is made of a nonmagnetic material, and includes a shaft body 281 having a round rod shape elongated in the moving direction of the movable iron core 270 (in the vertical direction: the drive-shaft direction) and a flange 282 having a substantially disk-like shape and extending outward in the radial direction from the upper end of the shaft body 281.

The bottom end of the shaft body 281 is inserted from above into the insertion hole 270a of the movable iron core 270 so that the shaft 280 is connected to the movable iron core 270.

The drive block 20 includes a plunger cap 290 made of a nonmagnetic material and having a bottomed cylindrical shape open on the upper side. The plunger cap 290 is placed between the fixed iron core 260 and the coil bobbin 220 and between the movable iron core 270 and the coil bobbin 220.

The plunger cap 290 includes a body 291 having a bottomed cylindrical shape open on the upper side, and a flange 292 extending outward in the radial direction from the upper end of the body 291. The body 291 of the plunger cap 290 is inserted into the insertion hole 220a located in the middle of the coil bobbin 220. A circular setting surface 223a is provided on the upper side of the coil bobbin 220 (on the upper flange 223) on which the flange 292 of the plunger cap 290 is placed.

The cylinder portion 261 of the fixed iron core 260 and the movable iron core 270 are housed in a housing space 290a of the plunger cap 290 placed in the cylindrical inner portion (in the insertion hole 220a) of the coil bobbin 220. The fixed iron core 260 is located on the opening side of the plunger cap 290, and the movable iron core 270 is located below the fixed iron core 260 inside the cylindrical plunger cap 290.

The cylinder portion 261 of the fixed iron core 260 and the movable iron core 270 are each formed into a cylindrical shape having an outer diameter which is substantially the same as the inner diameter of the plunger cap 290. The movable iron core 270 slides along the inside of the housing space 290a of the plunger cap 290 in the vertical direction (in the reciprocating direction: the drive-shaft direction).

In the present embodiment, the flange 292 located on the opening side of the plunger cap 290 is fixed to the periphery of an insertion hole 241a on the lower surface of the yoke upper plate 241. The lower end of the plunger cap 290 is inserted into the bushing 250 placed in the insertion hole 242c of the bottom wall 242a.

The movable iron core 270 placed on the bottom of the plunger cap 290 is magnetically connected to the circumferential surface of the bushing 250. In other words, the bushing 250 composes a magnetic circuit together with the yoke 240 (the yoke upper plate 241 and the yoke 242), the fixed iron core 260, and the movable iron core 270.

The yoke upper plate 241 is provided in the middle with the insertion hole 241a into which the fixed iron core 260 is inserted. The cylinder portion 261 of the fixed iron core 260 is inserted into the insertion hole 241a from the upper side of the yoke upper plate 241. The yoke upper plate 241 is provided, substantially in the middle on the upper surface, with a recess 241b having substantially the same diameter as the flange 262 of the fixed iron core 260 to prevent the flange 262 fitted to the recess 241b from falling off.

A holding plate 295 made of metal is placed on the yoke upper plate 241 with right and left edges fixed to the upper surface of the yoke upper plate 241. The holding plate 295 is provided with a protrusion in the middle protruding above the upper surface of the yoke upper plate 241 so as to define the space for housing the flange 262 of the fixed iron core 260.

The holding plate 295 is provided with an insertion hole 296 into which the shaft 280 is inserted. The upper end of the shaft 280 (on the flange 282 side) extends to the contact block 30 through the insertion hole 263 of the fixed iron core 260 and the insertion hole 296 of the holding plate 295.

When the current is applied to the coil 230, the attractive force acts on the movable iron core 270 so that the movable iron core 270 moves upward to the fixed iron core 260. The shaft 280 connected and fixed to the movable iron core 270 moves upward together.

The range of movement of the movable iron core 270 is between the initial position at which the movable iron core 270 is separated from and located below the fixed iron core 260 with the gap DI provided therebetween (the position the most distant from the fixed iron core 260) and the contact position at which the movable iron core 270 is brought into contact with the fixed iron core 260 (the position the closest to the fixed iron core 260).

The return spring 297 is placed between the movable iron core 270 and the holding plate 295 to bias the movable iron core 270 by the elastic force in the direction in which the movable iron core 270 returns to the initial position (in the direction away from the fixed iron core 260). In the present embodiment, the return spring 297 is a coil spring wound on the shaft 280 and placed inside the insertion hole 263 of the fixed iron core 260.

This configuration leads the opposed surface 264 of the fixed iron core 260 opposed to the movable iron core 270 and the opposed surface 271 of the movable iron core 270 opposed to the fixed iron core 260, which are a pair of magnetic poles, to heteropolarity when the current is applied to the coil 230, so that the movable iron core 270 moves to the contact position by the attractive force. Thus, in the present embodiment, the pair of the opposed surface 264 of the fixed iron core 260 and the opposed surface 271 of the movable iron core 270 function as magnetic pole faces when the current is applied to the coil 230.

When the current applied to the coil 230 is stopped, the movable iron core 270 returns to the initial position due to the biasing force of the return spring 297.

The movable iron core 270 according to the present embodiment reciprocates to separate from the fixed iron core 260 by the gap D1 when the current applied to the coil 230 is stopped and move toward the fixed member 260 by the attractive force when the current is applied to the coil 230.

The contact block 30 is located above the drive block 20, and opens and closes the contacts depending on the operation of turning ON/OFF for the application of the current to the coil 230.

The contact block 30 includes a box-shaped base 310 made of a heat-resistant material such as a ceramic material and open on the lower side. The base 310 includes a ceiling 311 and a circumferential wall 312 having a substantially square column shape extending downward from the peripheral edge of the ceiling 311.

The ceiling 311 of the base 310 is provided with two insertion holes 311a into which the fixed terminals 320 are inserted. The pair of (plurality of) the fixed terminals 320 is made of an electrically conductive material such as a copper material. Each of the fixed terminals 320 includes a fixed terminal body 321 having a substantially columnar shape inserted into the insertion hole 311a from above, and a flange 322 having a substantially disk-like shape extending outward in the radial direction from the upper end of the fixed terminal body 321 and fixed to the upper surface of the ceiling 311 (the upper surface of the circumference of the insertion hole 311a). The fixed contacts 321a are located on the bottom surfaces of the fixed contact bodies 321.

Although not shown in the drawings, a pair of terminals connected to an external load and the like is attached to the pair of the fixed terminals 320. The pair of terminals may be made of an electrically conductive material and formed into a plate shape.

The base 310 houses a movable contact arm 330 elongated across the pair of the fixed contacts 321a and including the movable contacts 330a located on the upper surface of the movable contact arm 330 to face the respective fixed contacts 321a. Although the present embodiment exemplifies the case in which the movable contacts 330a are integrated with the movable contact arm 330, the movable contacts 330a may be provided separately from the movable contact arm 330.

The movable contact arm 330 is attached to the shaft (the drive shaft) 280 such that the movable contacts 330a are separated from and opposed to the fixed contacts 321a with a predetermined gap provided therebetween when the current is not applied to the coil 230. The movable contact arm 330 moves upward together with the movable iron core 270 and the shaft 280 when the current is applied to the coil 230, so that the movable contacts 330a come into contact with the fixed contacts 321a. In the present embodiment, the moving direction of the movable contacts 330a substantially conforms to the reciprocating direction of the movable iron core 270 (the drive-shaft direction of the drive block 20).

In the present embodiment, the movable iron core 270 and the movable contact arm 330 are arranged such that the movable contacts 330a and the fixed contacts 321a are separated from each other when the movable iron core 270 is located in the initial position and come into contact with each other when the movable iron core 270 is located in the contact position. Accordingly, the fixed terminals 320 are electrically isolated from each other when the coil 230 is in the non-conducting state and the contact block 30 is thus turned off and electrically connected to each other when the coil 230 is in the conducting state and the contact block 30 is thus turned on.

The shaft (the drive shaft) 280 is attached to the middle of the movable contact arm 330 via a holder 360.

In the present embodiment, a yoke 370 is provided on the movable contact arm 330 so as to prevent contact welding caused by an electric arc.

More particularly, the yoke 370 includes an upper yoke (a first yoke) 371 located on the upper side of the movable contact arm 330, and a lower yoke (a second yoke) 372 located on the lower side of the movable contact arm 330.

The contact pressure between the movable contacts 330a and the fixed contacts 321a is ensured due to a pressure spring 340.

The pressure spring 340 is a coil spring of which the axial direction is parallel to the vertical direction.

The pressure spring 340 is arranged such that the upper end is inserted into an insertion hole 372a provided in the lower yoke (the second yoke) 372 and the lower end is fitted to a spring receiver 282a provided in the flange 282. The movable contact arm 330 is biased upward by the pressure spring 340.

The upper end of the pressure spring 340 is in contact with the lower surface 330b of the movable contact arm 330. According to the present embodiment, since the pressure spring 340 is placed to bias the movable contact arm 330 upward in the drive-shaft direction without contact with the lower yoke 372 (the yoke 370) (without the yoke interposed therebetween), a reduction in size of the contact device 10 (the drive block 20 and the contact block 30) in the height direction (in the vertical direction: the drive-shaft direction) can be achieved.

Further, in the present embodiment, gas is sealed in the base 310 in order to prevent occurrence of an electric arc between the movable contacts 330a and the fixed contacts 321a when the movable contacts 330a are separated from the fixed contacts 321a. The gas used may be mixed gas mainly including hydrogen gas superior in heat conductivity in a temperature range in which an electric arc occurs. In the present embodiment, an upper flange 380 covering the gap between the base 310 and the yoke upper plate 241 is provided so as to seal the gas therein.

More particularly, the base 310 includes the ceiling 311 provided with the pair of the aligned insertion holes 311a and the circumferential wall 312 having a square column shape extending downward from the peripheral edge of the ceiling 311, and is formed into a hollow box shape open on the lower side (on the movable contact arm 330 side), as described above. The base 310 is fixed to the yoke upper plate 241 via the upper flange 380 in a state in which the movable contact arm 330 is housed inside the circumferential wall 312 from the opening on the lower side.

The peripheral edge of the opening on the lower side of the base 310 is preferably airtightly connected to the upper surface of the upper flange 380 by silver brazing. In addition, the lower surface of the upper flange 380 is preferably airtightly connected to the upper surface of the yoke upper plate 241 by arc welding or the like. Further, the lower surface of the yoke upper plate 241 is preferably airtightly connected to the flange 292 of the plunger cap 290 by arc welding or the like. Accordingly, the seal space S for sealing the gas can be ensured in the base 310.

The contact block 30 of the present embodiment includes a housing case provided with the seal space S serving as a housing space for housing a contact unit 300. The housing case according to the present embodiment is composed of the base 310 and the upper flange 380. The housing case may only include the base 310 made of a heat-resistant material such as a ceramic material.

According to the present embodiment, the members located in the housing space (the seal space S) of the housing case are collectively defined as the contact unit 300 included in the contact block 30. The contact unit 300 thus not only includes the fixed contacts 321a and the movable contacts 330a but also includes the pressure spring 340 and the holder 360.

A capsule yoke is preferably used in addition to the gas in order to prevent the occurrence of an electric arc. The capsule yoke may be composed of a magnetic member having a substantially U-shape and made of a magnetic material such as iron, and a pair of permanent magnets.

An insulating member 350 is also provided in the opening of the base 310 in order to insulate the connected portion between the base 310 and the upper flange 380 against an electric arc caused between the fixed contacts 321a and the movable contacts 330a.

The insulating member 350 has a substantially rectangular cuboid open on the upper side and made of an insulating material such as a ceramic material or synthetic resin, and includes a bottom wall 351 and a circumferential wall 352 extending upward from the periphery of the bottom wall 351. The upper end of the upper flange 380 is brought into contact with the circumferential wall 352 on the upper side. The insulating member 350 thus insulates the connected portion between the base 310 and the upper flange 380 from the contact unit including the fixed contacts 321a and the movable contacts 330a.

The bottom wall 351 of the insulating member 350 is provided with an insertion hole 351a into which the shaft 280 is inserted.

Next, the operation of the contact device 10 (the electromagnetic relay 1) is described below.

When the current applied to the coil 230 is stopped, the movable iron core 270 moves in the direction away from the fixed iron core 260 due to the elastic force of the return spring 297, so that the movable contacts 330a are separated from the fixed contacts 321a, as shown in FIG. 1 and FIG. 2.

When the coil 230 is switched from the off state to the conducting state, the movable iron core 270 moves upward (toward the fixed iron core 260) due to the electromagnetic force and comes closer to the fixed iron core 260 against the elastic force of the return spring 297. In association with the upward movement of the movable iron core 270 (toward the fixed iron core 260), the shaft 280 and the other members including the upper yoke 371, the movable contact arm 330, the lower yoke 372, and the holder 360 attached to the shaft 280 move upward (toward the fixed contacts 321a). As a result, the movable contacts 330a of the movable contact arm 330 are brought into contact with and electrically connected to the fixed contacts 321a of the fixed terminals 320, so that the contact device 10 (the electromagnetic relay 1) is turned on.

The contact device 10 according to the present embodiment can detect the operation of the contact unit 300 (the contact-separation state between the movable contacts 330a and the fixed contacts 321a) with high accuracy.

In particular, a window portion 40 having higher light transmission than a wall portion of the base 310 composing at least part of the housing case is provided on the wall portion, so as to detect the operation of the contact unit 300 in the state in which gas is sealed in the seal space S.

According to the present embodiment, as shown in FIG. 1 and FIG. 2, the window portion 40 penetrates the circumferential wall 312 in the thickness direction. More particularly, the window portion 40 penetrates the circumferential wall 312 having a thickness in the direction (in the horizontal direction in FIG. 1 and FIG. 2) perpendicular to (intersecting) the moving direction (the vertical direction) of the movable contacts 330a.

The window portion 40 is provided on each of paired wall portions opposed to each other with the seal space (the housing space) S provided therebetween. Further, the paired window portions 40 are located on the paired wall portions with the fixed contacts 321a interposed therebetween. The paired window portions 40 are opposed to each other in the direction (in the horizontal direction in FIG. 1 and FIG. 2) perpendicular to (intersecting) the moving direction of the movable contacts 330a. The fixed contacts 321a are positioned within a region defined by the window portions 40 as viewed in the horizontal direction. The window portions 40 may be made of a silicone material.

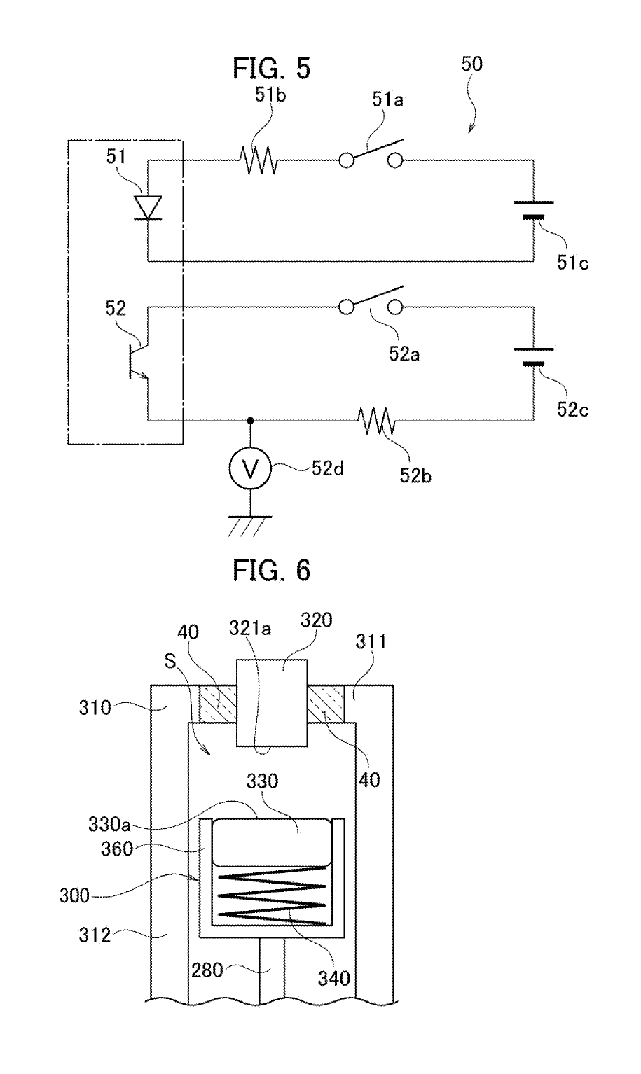

The contact device 10 preferably includes a detection unit 50 including a light-emitting portion 51 for emitting light and a light-receiving portion 52 for receiving light. The detection unit 50 may be a conventionally-known detection unit as shown in FIG. 5.

FIG. 5 illustrates the detection unit 50 including the light-emitting portion 51 using a light-emitting element for converting an electrical signal into light to emit the light and the light-receiving portion 52 using a light-receiving element for converting the received light into an electrical signal to output the signal. FIG. 5 also illustrates the circuit on the light-emitting portion 51 side including a switch 51a, a resistor 51b, and an electrode 51c, and the circuit on the light-receiving portion 52 side including a switch 52a, a resistor 52b, an electrode 52c, and a voltmeter 52d. The detection unit 50 is not intended to be limited to the circuit configuration shown in FIG. 5 and may have any circuit configuration.

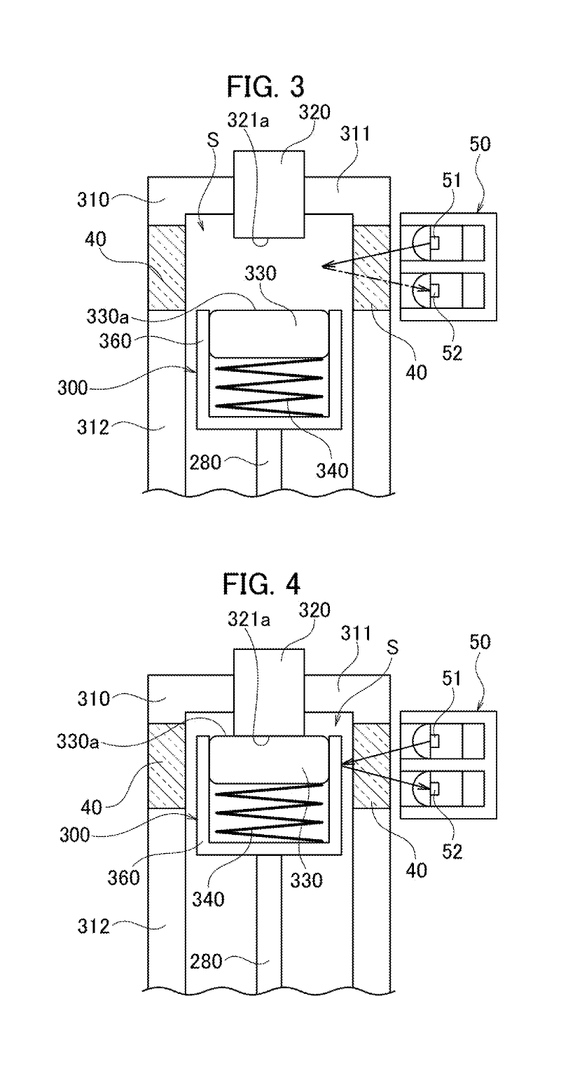

As shown in FIG. 3 and FIG. 4, the detection unit 50 is arranged such that the window portion 40 is located between the light-emitting and light-receiving portions 51 and 52 and the fixed contact 321a, so as to detect the operation of the contact unit 300 by the detection unit 50.

When the light is emitted from the light-emitting portion 51 in the state in which the movable contacts 330a are separated from the fixed contacts 321a, for example, most of the incident light is not reflected in the seal space S but passes through the seal space S toward the outside. Accordingly, a small amount of light is received by the light-receiving portion 51, so that the detection unit 50 confirms that the movable contacts 330a are separated from the fixed contacts 321a.

When the light is emitted from the light-emitting portion 51 in the state in which the movable contacts 330a are in contact with the fixed contacts 321a, most of the incident light is reflected by the movable contact arm 330 and the holder 360 inside the seal space S and then introduced into the light-receiving portion 52. Accordingly, a large amount of light is received by the light-receiving portion 51, so that the detection unit 50 confirms that the movable contacts 330a are in contact with the fixed contacts 321a.

Although the present embodiment exemplifies the case in which the window portion 40 is provided on each of the wall portions opposed to each other with the seal space (the housing space) S provided therebetween, one of the wall portions may be provided with the window portion 40.

The detection unit 50 is preferably arranged such that the window portion 40 is provided between the detection unit 50 and the fixed contact portions 321a. Accordingly, the detection unit 50 can detect the operation of the contact unit 300 depending on the amount of light received by the light-receiving portion 52.

The contact unit 300 preferably includes a high light-reflective surface at a portion (such as the movable contact arm 330 and the holder 360) facing the window portion 40 to reflect the light introduced through the window portion 40 in the state in which the movable contacts 330a are in contact with the fixed contacts 321a. The high light-reflective surface may be made of metal having a mirror surface obtained by polishing or an insulating material having a flat surface.

Alternatively, the contact unit 300 may include a diffuse reflecting surface at a portion facing the window portion 40. The diffuse reflecting surface may be made of metal having a roughened surface obtained by blasting, a flat plate to which fine particles adhere, or ceramics or resin molded with a rugged die.

The portion in the contact unit 300 facing the window portion 40 may have both the high light-reflective surface and the diffuse reflecting surface.

The window portion 40 may be provided on the ceiling (the wall portion) 311 having a thickness in the moving direction of the movable contacts 330a, as shown in FIG. 6.

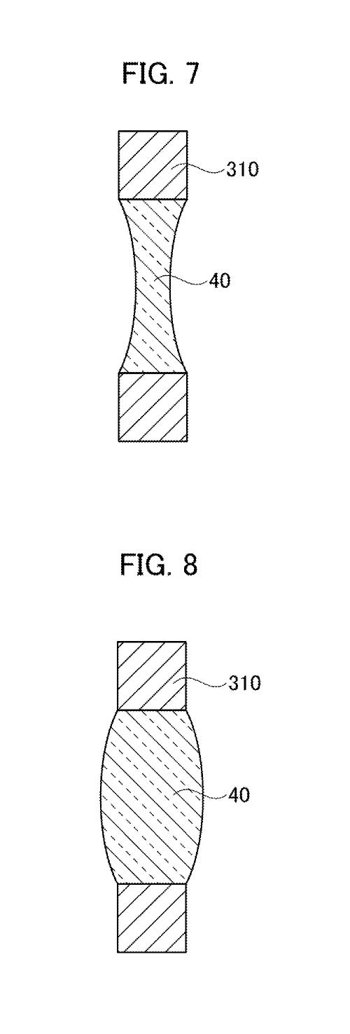

The window portion 40 may have a concave lens shape in cross section as shown in FIG. 7, or may have a convex lens shape in cross section as shown in FIG. 8.

A metal frame 60 may be used for fixing the window portion 40 to the wall portion of the housing case. In particular, the window portion 40 may be fixed to the wall portion of the housing case in a state in which the metal frame 60 is attached to the periphery of the window portion 40.

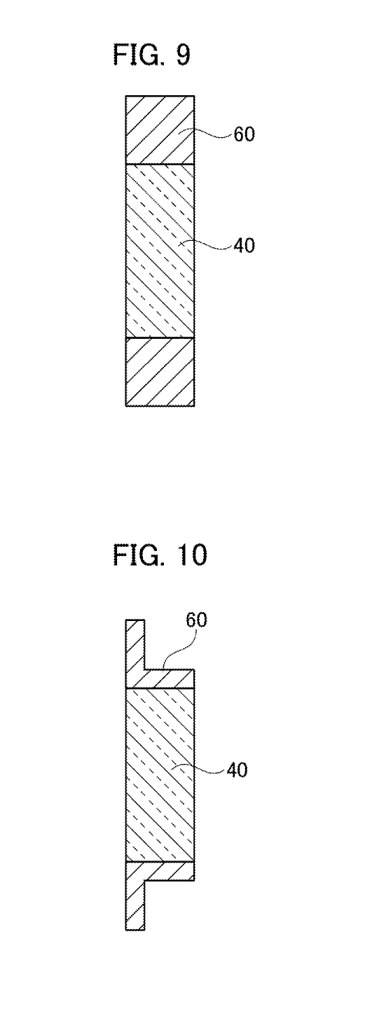

The shape of the metal frame 60 used may be any shape. For example, the metal frame 60 may have a cylindrical shape covering the entire outline of the window portion 40 as shown in FIG. 9, or may include a cylindrical portion covering the entire outline of the window portion 40 and a flange integrated with one end of the cylindrical portion as shown in FIG. 10.

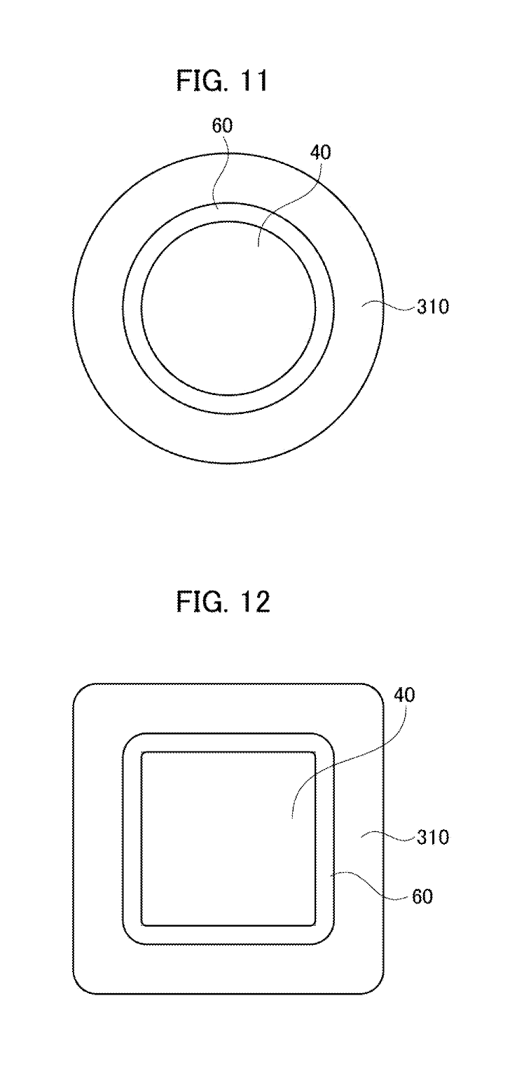

The outline of the window portion 40 may be any shape. For example, the outline of the window portion 40 may have a circular shape as shown in FIG. 11, or may have a polygonal (square) shape as shown in FIG. 12.

The outline of the window portion 40 may also be any shape when the window portion 40 is directly fixed to the wall portion of the housing case without the use of the metal frame 60.

The contact device 10 does not necessarily include the detection unit 50. The operation of the contact unit 300 may be confirmed visually.

As described above, the contact device 10 according to the present embodiment includes the contact block 30 including the fixed contacts 321a and the movable contacts 330a brought into contact with and separated from the fixed contacts 321a, and the drive block 20 for bringing the movable contacts 330a into contact with the fixed contacts 321a and separating the movable contacts 330a from the fixed contacts 321a.

The contact block 30 includes the contact unit 300 including the fixed contacts 321a and the movable contacts 330a, the housing case (the base 310 and the upper flange 380) having the seal space (the housing space) S for housing the contact unit 300, and the window portion 40 provided on the wall portion (the circumferential wall 312 or the ceiling 311) of the housing case and having higher light transmission than the wall portion.

This configuration allows the contact device 10 to detect the operation of the contact unit 300 sealed in the seal space (the housing space) S, so as to improve the accuracy of confirmation of the operation of the contact unit 300.

The housing case (the base 310 and the upper flange 380) according to the present embodiment is used for the contact device 10.

The electromagnetic relay 1 according to the present embodiment is equipped with the contact device 10.

The present embodiment thus can provide the contact device 10 capable of accurately detecting the operation of the contact unit 300, the housing case (the base 310 and the upper flange 380) used for the contact device 10, and the electromagnetic relay 1 equipped with the contact device 10.

The window portion 40 may be provided on the wall portion (the circumferential wall 312) having a thickness in the direction intersecting the moving direction of the movable contacts 330a.

Since the movement of the movable contacts 330a can be detected in the direction intersecting the moving direction of the movable contacts 330a, the operation of the movable contacts 330a can easily be confirmed.

The window portion 40 may be provided on the wall portion (the ceiling 311) having a thickness in the moving direction of the movable contacts 330a.

Since the window portion 40 is located at a position relatively not subjected to an electric arc, the light transmitting performance of the window portion 40 can be maintained for a longer period of time than a case in which the window portion 40 is provided at a position where an electric arc easily reaches.

The contact unit 300 may have a high light-reflective surface at a portion facing the window portion 40.

The high light-reflective surface improves the reflectivity of light, so as to detect the operation of the contact unit 300 more accurately.

The contact unit 300 may have a diffuse reflecting surface at a portion facing the window portion 40.

Since the diffuse reflecting surface diffusely reflects the incident light emitted from the light-emitting portion 51 into the seal space S, the light receiving area can be widened.

The window portion 40 may be provided on each of the paired wall portions opposed to each other with the seal space (the housing space) S provided therebetween.

Since light is further introduced from the opposite wall portion, the amount of the incident light introduced into the seal space (the housing space) S increases, so as to further facilitate the inspection of the seal space (the housing space) S (the detection of operation of the contact unit 300).

The window portion 40 may be provided on each of the paired wall portions opposed to each other with the fixed contacts 321a interposed therebetween.

The operation of the contact unit 300 can be detected depending on the amount of light transmitted through the window portion 40 provided on each of the paired wall portions, so as to improve the accuracy of the detection.

The window portion 40 may have a concave lens shape in cross section.

The concave lens shape can widen the visual range inside the seal space (the housing space) S.

The window portion 40 may have a convex lens shape in cross section.

The convex lens shape can enlarge a portion to be detected in the seal space (the housing space) S, so as to improve the accuracy of the detection.

The window portion 40 may be made of a silicone material.

The window portion 40 made of a silicone material only transmits predetermined wavelengths of light, so as to selectively receive light having a wavelength necessary for the detection.

The window portion 40 may be fixed to the wall portion via the metal frame 60 attached to the periphery of the window portion 40.

The metal frame 60 further facilitates the connection between the window portion 40 and the housing case while keeping the airtight conditions in the seal space (the housing space) S.

The contact device 10 may further include the detection unit 50 including the light-emitting portion 51 for emitting light and the light-receiving portion 52 for receiving light.

The detection unit 50 may be arranged such that the window portion 40 is located between the light-emitting and light-receiving portions 51 and 52 and the fixed contacts 321a.

This arrangement allows the detection unit 50 to detect the operating conditions of the contact unit 300 in a contactless manner through the window portion 40.

While the present invention has been described above by reference to the preferred embodiment, the present invention is not intended to be limited to the descriptions thereof, and various modifications will be apparent to those skilled in the art.

For example, although the embodiment exemplified the case in which the yoke 370 includes the upper yoke 371 and the lower yoke 372, the yoke 370 may include one of the upper yoke 371 and the lower yoke 372, or the contact device of the embodiment may exclude the yoke 370.

Although the embodiment exemplified the case in which the pressure spring 340 is inserted into the insertion hole 372a of the lower yoke 372, the pressure spring 340 may be in contact with the lower yoke 372.

The coil bobbin 220 may have various kinds of shapes, and the position of the coil bobbin 220 may be varied as appropriate.

Although the embodiment exemplified the case in which the housing space for housing the contact unit in the contact case serves as an airtight seal space, the contact unit may be housed in a housing space without airtightness.

The specifications (such as the shape, size, and layout) of the housing case, the window portion, and other elements may also be varied as appropriate.

1. A contact device comprising:
a contact block including fixed contacts and movable contacts brought into contact with and separated from the fixed contacts; and
a drive block configured to bring the movable contacts into contact with the fixed contacts and separate the movable contacts from the fixed contacts,
the contact block including:
a contact unit including the fixed contacts and the movable contacts;
a housing case having a housing space for housing the contact unit; and
a window portion provided on a wall portion of the housing case and having higher light transmission than the wall portion.

2. The contact device according to claim 1, wherein the window portion is provided on the wall portion having a thickness in a direction intersecting a moving direction of the movable contacts.

3. The contact device according to claim 1, wherein the window portion is provided on the wall portion having a thickness in a moving direction of the movable contacts.

4. The contact device according to claim 1, wherein the contact unit includes a high light-reflective surface at a portion facing the window portion.

5. The contact device according to claim 1, wherein the contact unit includes a diffuse reflecting surface at a portion facing the window portion.

6. The contact device according to claim 1, wherein the window portion is provided on each of paired wall portions opposed to each other with the housing space provided therebetween.

7. The contact device according to claim 6, wherein the window portion is provided on each of the paired wall portions opposed to each other with the fixed contacts interposed therebetween.

8. The contact device according to claim 1, wherein the window portion has a concave lens shape in cross section.

9. The contact device according to claim 1, wherein the window portion has a convex lens shape in cross section.

10. The contact device according to claim 1, wherein the window portion is made of a silicone material.

11. The contact device according to claim 1, wherein the window portion is fixed to the wall portion via a metal frame attached to a periphery of the window portion.

12. The contact device according to claim 1, further comprising a detection unit including a light-emitting portion for emitting light and a light-receiving portion for receiving light,
the detection unit being arranged such that the window portion is located between the light-emitting and light-receiving portions and the fixed contacts.

13. A housing case used for the contact device according to claim 1.

14. An electromagnetic relay equipped with the contact device according to claim 1.
